(19) United States
(12) Patent Application Publication
(10) Pub. No.: US 2024/0146082 A1
(43) Pub. Date: May 2, 2024

(54) Power Tool Universal Adapter

(71) Applicant: James Downes, New Lisbon, WI (US)

(72) Inventor: James Downes, New Lisbon, WI (US)

(21) Appl. No.: 18/233,784

(22) Filed: Aug. 14, 2023

Related U.S. Application Data
(60) Provisional application No. 63/420,210, filed on Oct. 28, 2022.

(51) Int. Cl. H02J 7/00

(52) U.S. Cl. CPC H02J 7/0045; H02J 7/0049

(57) ABSTRACT

The power tool adapter is the only product of its kind that offers a standalone charger built to be compatible with any and all hardware tools presently on the market. This unprecedented device is uniquely designed with durable, high-quality materials, a battery slot to ensure long-term sustainability and provides professional or laymen, alike, with a highly portable universal charger.

The present utility patent application claims priority to the Provisional Patent Application 63/420,210 filed Oct. 28, 2022 for James Downes titled Power Tool Universal Adapter incorporated by reference in its entirety.

### BACKGROUND

A common problem among many auto mechanics, construction workers, and independent contractors when using power tools is their constant need to be recharged, whereas work has to halt to effectively power supplies and often each tool requires a specific type of charger. To ensure effectiveness, individuals tend to carry numerous chargers of different brands and purposes, to and from every work operation, which can be incredibly inconvenient, heavy to transport and a nuisance to manage overall. There have been no products available as original equipment or as an aftermarket to address this problem.

An apparatus to simplify the process of having to charge several different types of power tools without having to carry a lot of heavy and inconvenient supplies around is not being met by any known device or system at present. There have been no products available as original equipment or as an aftermarket to address this problem either.

### SUMMARY OF THE INVENTION

The main purpose of the power tool universal adapter is to provide users with a complementary charger that can support wireless tools, such as; drills, sawzalls, hand saws, and grinders.

A disclosed power tool adapter includes a multiport charging pad and charging mount comprising complementary battery charging fixtures for a plurality of power tool brands and a set of port status indicators. The disclosure also includes a port indicator for each of the complementary battery charging fixtures and configured to indicate a correspondence of the set of port status indicators thereto. The disclosure additionally includes a sequential port switch configured to step through the correspondence of the set of port status indicators to a respective port indicator on a one to one relation of a depression of the sequential port switch to the correspondence.

### BRIEF DESCRIPTION OF THE DRAWINGS

FIG. 1 is a top perspective view of the power tool charging adapter in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

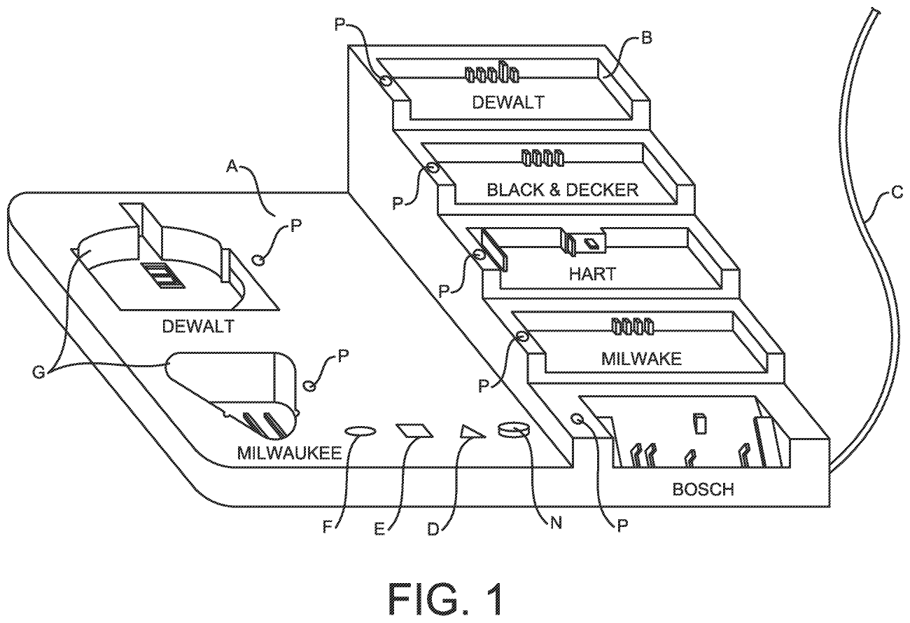

FIG. 1 is a top perspective view of the power tool charging adapter showing: portable multi-charging pad referenced as A, stair-type charger mount referenced as B, power cord referenced as C, low battery indicator referenced as D, fully charged indicator referenced as B, charging indicator referenced as F, battery slot referenced as a sequential port switch N, and a port indicator P for each of the complementary battery charging fixture in accordance with an embodiment of the present disclosure.

The present disclosed power tool charging adapter, also known as “Apollo Power Chargers,” offers a modern accessory that allows users to charge all of their tools, regardless of brand, with one universal charging device permit-ting users to streamline operation. The Apollo Power Chargers introduces a novel portable pad with a multi-star type charging mount. Users can conveniently and directly plug in their power tools into the charger pad to activate the charging. With advanced technology, the device will indicate when the tools are on low battery, charging and when they are fully powered for utilization. The Apollo Power Chargers eliminates the need for individuals to carry or amass varying chargers for their tools, each time they are working, and ensures they have access to a primary charging unit able to meet any commercial or D.I.Y. project, at all times. This innovative, top-quality product will benefit all individuals who seek to have a more practical and effective means of charging their tools, especially while on the go.

The disclosure allows a single set of status indicators to be used for multiple charging devices one at a time and also all at once.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A power tool adapter, comprising;
a multiport charging pad and charging mount comprising complementary battery charging fixtures for a plurality of power tool brands and a set of port status indicators;
a port indicator for each of the complementary battery charging fixtures and configured to indicate a correspondence of the set of port status indicators thereto; and
a sequential port switch configured to step through the correspondence of the set of port status indicators to a respective port indicator on a one to one relation of a depression of the sequential port switch to the correspondence.

2. The power tool adapter of claim 1, wherein the plurality of power tool brands include Dewalt®, Black and Decker®, Hart®, Milwuakee®, and Bosch®.

3. The power tool adapter of claim 1, wherein the set of port status indicators comprise a low battery indicator, a fully charged indicator and a charging indicator.

4. The power tool adapter of claim 1, wherein the charging mount comprises a stair-type charging mount.

5. The power tool adapter of claim 1, wherein the complementary battery charging fixtures include a female receptacle to a power tool charging fixture.

6. The power tool adapter of claim 1, wherein the complementary battery charging fixtures include a male receptacle to a power tool charging fixture.

7. The power tool adapter of claim 1, wherein the port indicator comprises a light for each of the complementary battery charging fixtures.

8. The power tool adapter of claim 1, wherein the port indicator comprises an audible beep configured to sound a number of times corresponding to a number of a respective complementary battery charging fixture.

9. The power tool adapter of claim 1, wherein the sequential port switch starts at a first port indicator correspondence and with a depression of the sequential port switch moves to a second port indicator correspondence.

10. The power tool adapter of claim 1, wherein the sequential port switch starts at a previous port indicator correspondence and with a depression of the sequence port switch moves to a subsequent port indicator correspondence.

11. The power tool adapter of claim 1, wherein each of the complementary battery charging fixtures are wired in a parallel configuration with respect to a power and a ground wiring.

12. The power tool adapter of claim 1, wherein each of the port indicators are wired in series with a respective complementary battery charging fixture.

13. The power tool adapter of claim 1, further comprising a fuse wired in series with a power supply and ground circuit for the power tool adapter.

14. The power tool adapter of claim 1, further comprising a transformer circuit for the power supply and ground circuit for the power tool adapter to step down a household alternating voltage and current to a lower voltage with direct current.

15. The power tool adapter of claim 1, wherein a lingering depression of the sequential port switch steps sequentially through each of a first port correspondence to a last port correspondence.
